(19) United States
(12) Patent Application Publication
(10) Pub. No.: US 2015/0019270 A1
(43) Pub. Date: Jan. 15, 2015

(54) OPERATOR BENEFITS AND REWARDS THROUGH SENSORY TRACKING OF A VEHICLE

(71) Applicants: Brad Jarvis, Newport Beach, CA (US); Richard Frank Pearlman, Carlsbad, CA (US); Sean Micheal Walsh, Redwood City, CA (US); Daris Amon Schantz, Scottsdale, AZ (US); Steven Gertz, Smyrna, GA (US); Alec Michael Hale-Pletka, La Palma, CA (US)

(72) Inventors: Brad Jarvis, Newport Beach, CA (US); Richard Frank Pearlman, Carlsbad, CA (US); Sean Micheal Walsh, Redwood City, CA (US); Daris Amon Schantz, Scottsdale, AZ (US); Steven Gertz, Smyrna, GA (US); Alec Michael Hale-Pletka, La Palma, CA (US)

(21) Appl. No.: 14/489,539

(22) Filed: Sep. 18, 2014

Related U.S. Application Data
(63) Continuation-in-part of application No. 14/022,241, filed on Sep. 10, 2013.
Application No. 14/022,241 is a continuation-in-part of application No. 13/941,471, filed on Jul. 13, 2013.
Application No. 13/941,471 is a continuation of application No. 13/421,571, filed on Mar. 15, 2012, now Pat. No. 8,510,200.
Application No. 13/421,571 is a continuation-in-part of application No. 13/310,629, filed on Dec. 2, 2011.
Application No. 13/310,629 is a continuation-in-part of application No. 13/328,070, filed on Dec. 16, 2011.

(51) Int. Cl. G06Q 40/08; B60W 40/09

(52) U.S. Cl. CPC G06Q 40/08; B60W 40/09
USPC 705/4

(57) ABSTRACT

Disclosed are a method, a device and/or a system of an operator benefits and rewards through sensory tracking of a vehicle. In one aspect, a method includes associating a private vehicle with an individual. A behavior of the individual is monitored when the individual is operating the private vehicle. The method includes determining whether the individual is adhering to a set of parameters set by an entity. Information is presented to the individual that they have earned a credit towards a benefit based on operating of the private vehicle. The entity may be permitted to configure the set of parameters and set a weight to each of the set of parameters. A punitive measure may be provided when the set of parameters is violated. A curfew range may be set on the private vehicle such that a movement of the private vehicle is limited to the curfew range.

### CLAIM OF PRIORITY

This non-provisional patent application is a Continuation-In-Part (CIP) application of, claims priority to, and incorporates by reference in its entirety United States (U.S.) non-provisional patent application Ser. No. 14/022,241 titled ‘GEOSPATIAL DATA BASED ASSESSMENT OF FLEET DRIVER BEHAVIOR’ filed on Sep. 10, 2013. The patent application Ser. No. 14/022,241 is a CIP of U.S. non-provisional patent application Ser. No. 13/941,471 filed on Jul. 13, 2013, which, in turn, claims priority to: U.S. non-provisional patent application Ser. No. 13/421,571 filed on Mar. 15, 2012, now issued as U.S. Pat. No. 8,510,200, U.S. non-provisional application Ser. No. 13/310,629 filed on Dec. 2, 2011, and U.S. non-provisional application Ser. No. 13/328,070 filed on Dec. 16, 2011.

### FIELD OF THE TECHNOLOGY

This disclosure relates generally to the field of automotive technology, and more particularly, to an operator benefits and rewards through sensory tracking of a vehicle.

### BACKGROUND

Parties (e.g., insurance providers, and/or advertisers) may have a stake in the behavior of operators of private vehicles. It may be difficult to monitor and/or assess the behavior of operators of private vehicles through periodic “snapshot” views. Periodic accountability may not properly represent the behavior of operators and/or may fail to hold operators responsible for their actions.

In addition, parties may wish to encourage desired behavior of operators of private vehicles. Punitive based methods of controlling the behavior of operators of private vehicles may fail to facilitate adoption of desired behaviors and/or may discourage participation. A lack of ability to properly monitor and/or incentivize the behavior of operators of private vehicles may prevent interested parties from improving and/or gaining useful knowledge of the behavior of operators of private vehicles. This may result in loss of money and/or lives.

### SUMMARY

Disclosed are a method, a device and/or a system of an operator benefits and rewards through sensory tracking of a vehicle.

In one aspect, a method includes associating a private vehicle with an individual. A behavior of the individual is monitored when the individual is operating the private vehicle. The method includes determining whether the individual is adhering to a set of parameters set by an entity using a processor and memory. Information is presented to the individual that they have earned a credit towards a benefit based on operating of the private vehicle.

The entity may be permitted to configure the set of parameters and set a weight to each of the set of parameters. A punitive measure may be provided when the set of parameters is violated. A curfew range may be set on the private vehicle such that a movement of the private vehicle is limited to the curfew range. A set of sensors of the private vehicle may be monitored to determine a geospatial location and/or a condition of the private vehicle. An insurance policy may be set through an insurance provider based on adherence to the set of parameters.

A metadata may be generated including a behavioral trait of the individual operating the private vehicle. An advertiser may be selected that targets the behavioral trait in promotion of a product and/or a service. The advertiser may be presented with an advertising opportunity to the individual operating the private vehicle through a mobile device of the individual. A competition may be created between individuals of an insurance provider. The method may determine if a particular individual is adhering to the set of parameters set by the entity. The credit may be assigned to an individual when the individual adheres to the set of parameters set by the entity. The entity may be the insurance provider. The individual may be monitored by the entity.

In another aspect, a method includes associating a private vehicle with an individual. A behavior of the individual is monitored when the individual is operating the private vehicle. An entity is permitted to configure a set of parameters. The entity assigns a weight to each of the set of parameters. The method determines whether the individual is adhering to the set of parameters set by the entity using a processor and a memory.

In yet another aspect, a system includes a private vehicle associated with an individual. A central server is configured to monitor a behavior of the individual when the individual is operating the private vehicle. The system determines whether the individual is adhering to a set of parameters set by an entity using a processor and a memory. Information is presented to the individual that they have earned a credit toward a benefit based on the operating of the private vehicle by the individual.

A configure algorithm may permit the entity to configure the set of parameters including permitting the entity to set a weight to each of the set of parameters. A violation algorithm may provide a punitive measure when the set of parameters is violated. A curfew algorithm may set a curfew range on the private vehicle such that a movement of the private vehicle is limited to the curfew range. A monitoring algorithm may monitor a set of sensors of the private vehicle to determine a geospatial location and/or a condition of the private vehicle.

An insurance algorithm may set an insurance policy through an insurance provider based on adherence to the set of parameters. An affinity algorithm may generate a metadata may include a behavioral trait of the individual operating the private vehicle. An advertiser may be selected that targets the behavioral trait in promotion of a product and/or a service. The advertiser may be presented with an advertising opportunity to the individual operating the private vehicle through a mobile device of the individual. The entity may be the insurance provider.

A competition algorithm may create a competition between individuals of the insurance provider. An adherence algorithm may determine if an individual is adhering to the set of parameters set by the entity. A credit algorithm may assign the credit to the individual when the individual adheres to the set of parameters set by the entity. The individual may be monitored by the entity.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a network view of a central server communicatively coupled with a private vehicle of an individual through a network to monitor a behavior of the individual and provide benefits and rewards using a sensory tracking function of the central server, according to one embodiment.

FIG. 2 is an exploded view of the central server of FIG. 1 illustrating a credit function and a benefit function that apply different algorithms to provide benefits and rewards, according to one embodiment.

FIG. 3 is table view of the relationships between the individual, the private vehicle, and a set of parameters of FIG. 1, according to one embodiment.

FIG. 4 is table view illustrating the relationships between the set of parameters of FIG. 1 and the behavior function, according to one embodiment.

FIG. 5A is an insurance provider interface view of the set of parameters of FIG. 1 in a client device, according to one embodiment.

FIG. 5B is critical path view illustrating a parent using the central server of FIG. 1 to monitor a behavior of a child operating the private vehicle and provide benefits and rewards, according to one embodiment.

FIG. 6 is an advertising network view of the central server of FIG. 1 communicatively coupled with a behavioral trait data of the individual through the network of FIG. 1, according to one embodiment.

FIG. 7 is an interface view of the client device of FIG. 1 providing a benefit and a credit to the individual of FIG. 1, according to one embodiment.

FIG. 8 is critical path view illustrating an entity using the computer server of FIG. 1 to monitor a behavior of the individual operating the private vehicle, according to one embodiment.

FIG. 9 is a conceptual view of a reward provided to the individual either by the parent and/or the insurance provider when the private vehicle of the individual of FIG. 1 remains inside a curfew range, according to one embodiment.

FIG. 10 is a conceptual view of a punitive measure assessed to the individual either by the parent and/or the insurance provider when the private vehicle of the individual of FIG. 1 travels outside the curfew range, according to one embodiment.

FIG. 11 is a competition view of the students of a driving school competing for the recognition based on the set of parameters of FIG. 1 set by the driving school, according to one embodiment.

FIG. 12 is a process flow of the central server of FIG. 1 monitoring the behavior of the individual operating the private vehicle, according to one embodiment.

FIG. 13 is a schematic diagram of computing device that can be used to implement the methods and systems disclosed herein, according to one or more embodiments.

### DETAILED DESCRIPTION

Disclosed are a method, a device and/or a system of an operator benefits and rewards through sensory tracking of a vehicle.

In one embodiment, a method includes associating a private vehicle 102 with an individual 104A. A behavior data 106 of the individual 104A is monitored when the individual 104A is operating the private vehicle 102. The method includes determining whether the individual 104A is adhering to a set of parameters data 108 set by an entity 110 using a processor 128 and a memory 126. An information data 112 is presented to the individual 104A that they have earned a credit (e.g., using a credit function 114 of the central server 100) towards a benefit (e.g., using a benefit function 116 of the central server 100) based on operating of the private vehicle 102.

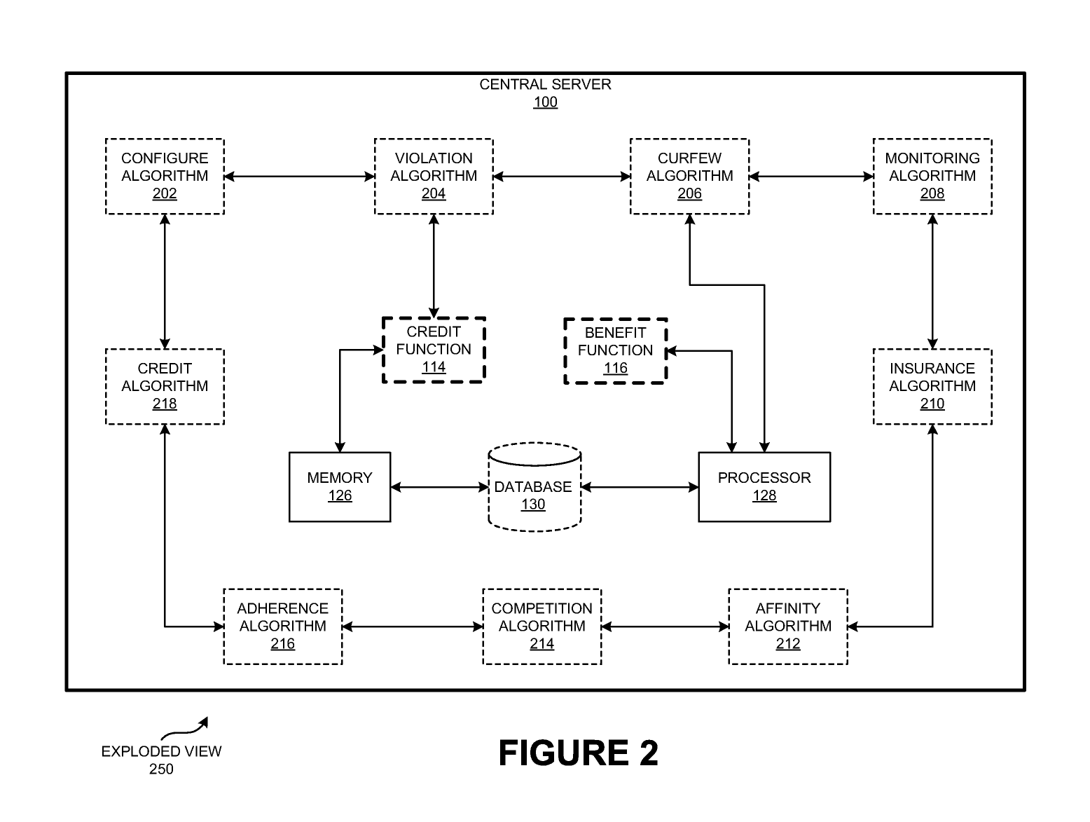

The entity 110 may be permitted to configure the set of parameters data 108 and set a weight to each of the set of parameters data 108. A punitive measure may be provided when the set of parameters data 108 is violated. A curfew range (e.g., using a sensory tracking function 120 of the central server 100) may be set on the private vehicle 102 such that a movement of the private vehicle 102 is limited to the curfew range (e.g., using a sensory tracking function 120 of the central server 100). A set of sensors 118 of the private vehicle 102 may be monitored to determine a geospatial location data 122 and/or a condition data 124 of the private vehicle 102. An insurance policy 113 may be set through an insurance provider 110A based on adherence to the set of parameters data 108 (e.g., using an insurance algorithm 210 of the central server 100 as shown in FIG. 2).

A metadata 602 may be generated including a behavioral trait data 604 of the individual 104A operating the private vehicle 102. An advertiser user 606 may be selected that targets the behavioral trait data 604 in promotion of a product and/or a service. The advertiser user 606 may be presented with an advertising opportunity function 608 to the individual 104A operating the private vehicle 102 through a mobile device 614 of the individual 104A. A competition (e.g. using a competition data 702) may be created between individuals 104 and the insurance provider 110A. The method may determine if a particular individual 104A is adhering to the set of parameters data 108 set by the entity 110. The credit (e.g., using a credit function 114 of the central server 100) may be assigned to an individual 104A when the individual 104A adheres to the set of parameters data 108 set by the entity 110. The individual 104A may be monitored by the entity 110. The entity 110 may be the insurance provider 110A.

In another embodiment, a method includes associating a private vehicle 102 with an individual 104A. A behavior (e.g., behavior data 106) of the individual 104A is monitored when the individual 104A is operating the private vehicle 102. An entity 110 is permitted to configure a set of parameters (e.g., a set of parameters data 108). The entity 110 assigns a weight to each of the set of parameters (e.g., a set of parameters data 108) using a processor 128 and a memory 126. The method determines whether the individual 104A is adhering to the set of parameters (e.g., a set of parameters data 108) set by the entity 110.

In yet another embodiment, a system includes a private vehicle 102 associated with an individual 104A. A central server 100 is configured to monitor a behavior (e.g., behavior data 106) of the individual 104A when the individual 104A is operating the private vehicle 102. The system determines whether the individual 104A is adhering to a set of parameters (e.g., a set of parameters data 108) set by an entity 110 using a processor 128 and a memory 126. An information (e.g., information data 112) is presented to the individual 104A that they have earned a credit (e.g., using a credit function 114 of the central server 100) toward a benefit (e.g., using a benefit function 116 of the central server 100) based on the operating of the private vehicle 102 by the individual 104A.

A configure algorithm 202 may permit the entity 110 to configure the set of parameters (e.g., a set of parameters data 108) including permitting the entity 110 to set a weight to each of the set of parameters (e.g., a set of parameters data 108). A violation algorithm 204 may provide a punitive measure when the set of parameters (e.g., a set of parameters data 108) is violated. A curfew algorithm 206 may set a curfew range on the private vehicle 102 such that a movement of the private vehicle 102 is limited to the curfew range. A monitoring algorithm 208 may monitor a set of sensors 118 of the private vehicle 102 to determine a geospatial location data 122 and/or a condition data 124 of the private vehicle 102.

An insurance algorithm 210 may set an insurance policy 113 through an insurance provider 110A based on adherence to the set of parameters data 108. An affinity algorithm 212 may generate a metadata 602 includes a behavioral trait data 604 of the individual 104A operating the private vehicle 102. An advertiser user 606 may be selected that targets the behavioral trait data 604 in promotion of a product function and/or a service function 612. The advertiser user 606 may be presented with an advertising opportunity function 608 to the individual 104A operating the private vehicle 102 through a mobile device 614 of the individual 104A. The entity 110 may be the insurance provider 110A.

A competition algorithm 214 may create a competition data 702 between individuals 104 and the insurance provider 110A. An adherence algorithm 216 may determine if an individual 104A is adhering to the set of parameters (e.g., set of parameters data 108) set by the entity 110. A credit algorithm 218 may assign the credit (e.g., using a credit function 114 of the central server 100) to the individual 104A when the individual 104A adheres to the set of parameters (e.g., set of parameters data 108) set by the entity 110. The individual 104A may be monitored by the entity 110.

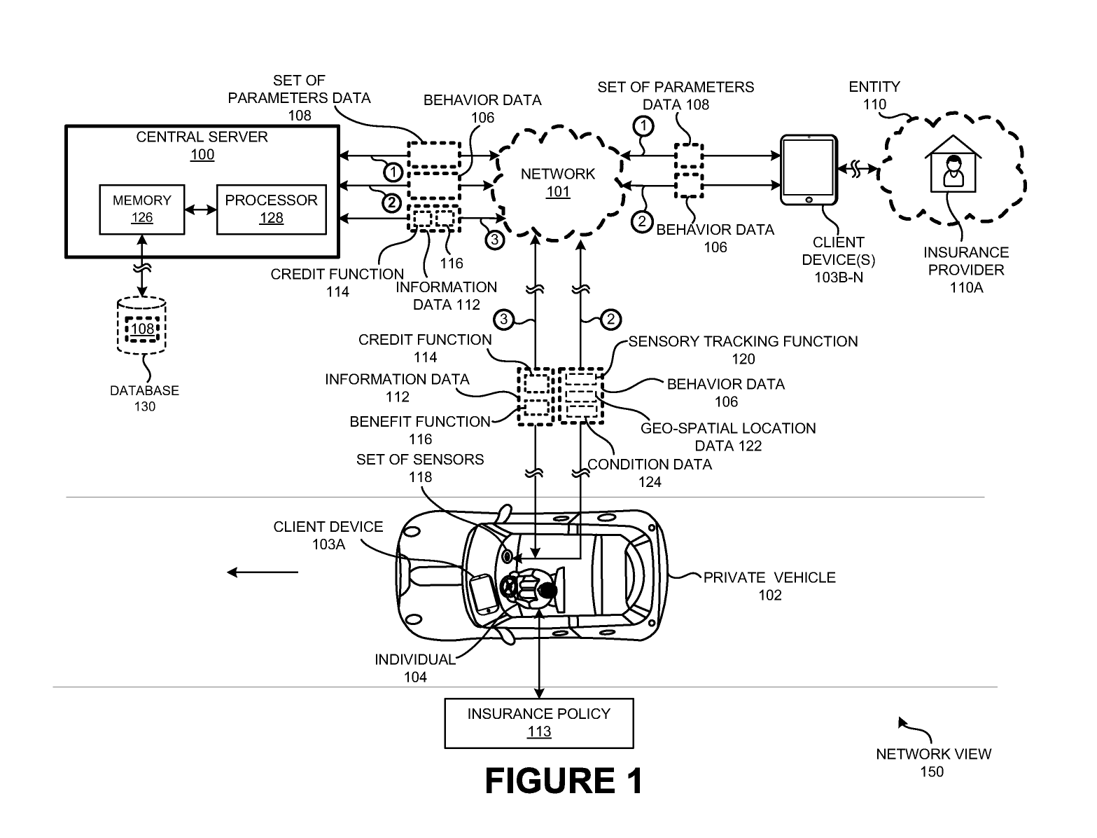

FIG. 1 is a network view 150 of a central server 100 communicatively coupled with a private vehicle 102 of an individual 104A through a network 101 to monitor a behavior of the individual 104A operating a private vehicle 102 and provide benefits and rewards using a sensory tracking function 120 of the central server 100, according to one embodiment. Particularly, FIG. 1 illustrates the central server 100, the network 101, the private vehicle 102, the client device(s) 103, the individual 104A, a behavior data 106, a set of parameters data 108, an entity 110, an insurance provider 110A, an information data 112, an insurance policy 113, a credit function 114, a benefit function 116, a set of sensors 118, a sensory tracking function 120, a geospatial location data 122, a condition data 124, a memory 126, a processor 128 and a database 130, according to one embodiment.

Particularly, FIG. 1 illustrates the central server 100 may be a computer system that provides local area networking services to multiple users, according to one embodiment. The network 101 may be a supportive system of sharing information and services among individuals and groups having a common interest (e.g., wide area network, wireless network, ad hoc network) according to one embodiment. The private vehicle 102 may be a machine that transports a person and/or goods from one location to another (e.g., a car, a truck, a bus) that is operated by the individual 104A, according to one embodiment.

The client device(s) 103 may be computer hardware and/or software that accesses a service made available by the central server 100, according to one embodiment.

The individual 104A may be a person (e.g., a child, an adult, a newly insured driver, a student of driving school) that operates and/or controls the private vehicle 102, according to one embodiment. A behavior data 106 may be information collected from the measuring and/or recording of the behavior of the individual 104A while driving the private vehicle 102, according to one embodiment.

A set of parameters data 108 may be numerical and/or other measurable factors (e.g. speed of driving, geospatial location of the private vehicle, rate of acceleration) that are defined by the entity 110 as items that are requested to be monitored in the operation of private vehicle 102 by the individual 104A, according to one embodiment. An entity 110 may be an organization, a person and/or a business (e.g., insurance provider 110A, parent 110B, and/or a driving school operator 110C) that communicates with the central server 100 using the client device(s) 103, according to one embodiment. An insurance provider 110A may be a system, a company, and/or body providing financial protection for property, life against specified contingencies, loss, and/or damage, and involving payment of regular premiums in return for a policy guaranteeing such protection, according to one embodiment.

An information data 112 may include information regarding attributes (e.g., age, sex, date of birth, name, license no., and driving experience) of the individual 104A, according to one embodiment. An insurance policy 113 may be a contract for financial protection for property and/or life against specified contingencies, such as loss, and/or damage, and/or involving payment of regular premiums guaranteeing such protection, according to one embodiment. A credit function 114 may be a set of instructions that ensure that the individual 104A receives a credit (e.g., an entry recording a sum received) when provided with the benefit based upon driving behavior of the individual 104A, according to one embodiment. A benefit function 116 may be a set of instructions that ensure that the individual 104A receives a benefit (e.g., a reward, a coupon from an advertiser) when the driving behavior of the individual falls within a set of parameters (e.g., a set of parameters data 108) defined by the entity 110, according to one embodiment. A set of sensors 118 may be an assembly of devices that detects events and/or changes in quantities and provides a corresponding output, generally as an electrical and/or optical signal (e.g., speed sensor, parking sensor, a GPS sensor, a tracking sensor), according to one embodiment.

A sensory tracking function 120 may be a set of function that detects events and/or changes in quantities and provides a corresponding output, generally as an electrical and/or optical signal, according to one embodiment. A geospatial location data 122 may be the information that identifies the characteristics of natural and/or constructed features and boundaries on the street, road, neighborhood, typically represented by points, lines, polygons, and/or complex geographic features, according to one embodiment.

A condition data 124 may be the information about the condition of the private vehicle 102, according to one embodiment. A memory 126 may be a physical device used to store programs and/or data on a temporary and/or permanent basis for use in a computer and/or other digital electronic device forming the central server 100, according to one embodiment.

A processor 128 may be a central processing unit (CPU) within the central server 100 that carries out the instructions of a computer program by performing the basic arithmetical, logical, and input/output operations, according to one embodiment. A database 130 may be an organized collection of data that can be accessed immediately and manipulated by a central server 100, according to one embodiment.

FIG. 1 illustrates the central server 100 communicatively coupled with the client device(s) 103B-N of the entity 110 and the private vehicle 102 of the individual 104A through the network 101 based on the set of parameters (e.g., a set of parameters data 108). The central server 100 may include the memory 126 communicatively coupled with the database 130 and the processor 128. The private vehicle 102 of the individual 104A may include the set of sensors 118. The individual 104A operating the private vehicle 102 may contain the client device 103A (e.g., a mobile phone). The individual 104A operating the private vehicle 102 may be insured with the insurance policy 113.

The entity 110 of FIG. 1 may include the insurance provider 110A, the parent 110B and/or the driving school operator 110C. In circle ‘1’, the entity 110 may set the parameters data 108 using the processor 128 and the memory 126. In circle ‘2’, the entity 110 may monitor the behavior of the individual 104A operating the private vehicle 102 based on the set of parameters (e.g., a set of parameters data 108). In circle ‘3’, the information to the individual 104A may be presented that they have earned the credit towards a benefit based on the operating of the private vehicle 102 by the individual 104A.

FIG. 2 is an exploded view 250 of the central server 100 illustrating a credit function 114 and a benefit function 116 that apply different algorithms to provide benefits and rewards, according to one embodiment. Particularly, FIG. 2 illustrates a configure algorithm 202, a violation algorithm 204, a curfew algorithm 206, a monitoring algorithm 208, an insurance algorithm 210, an affinity algorithm 212, a competition algorithm 214, an adherence algorithm 216, a credit algorithm 218, according to one embodiment.

A configure algorithm 202 may be a process to permit the entity 110 to organize the set of parameters (e.g., a set of parameters data 108) including permitting the entity 110 to set a weight to each of the set of parameters (e.g., a set of parameters data 108), according to one embodiment. A violation algorithm 204 may be a set of rules to provide a punitive measure when the set of parameters (e.g., a set of parameters data 108) is disturbed by the individual 104A of the private vehicle 102, according to one embodiment. A curfew algorithm 206 may include setting a restriction on the private vehicle 102 of an individual 104A such that a movement of the private vehicle 102 is limited to the curfew range, according to one embodiment.

A monitoring algorithm 208 may be a process of watching the private vehicle 102 to determine a geospatial location (e.g., a geospatial location data 122) and a condition (a condition data 124) of the private vehicle 102, according to one embodiment. An insurance algorithm 210 may be a process to determine the insurance policy 113 of the individual 104A of the private vehicle 102 through an insurance provider 110A based on at least adherence to the set of parameters (e.g., a set of parameters data 108), according to one embodiment.

An affinity algorithm 212 may select an advertiser user 606 that targets the behavioral trait (e.g., behavioral trait data 604) in promotion of a product and/or a service. The advertiser user 606 may be presented with an advertising opportunity to the individual 104A operating the private vehicle 102 through a mobile device 614 of the individual 104A, wherein the entity 110 is the insurance provider 110A, according to one embodiment. A competition algorithm 214 may create a rivalry between the individuals 104 who are insured by the insurance provider 110A driving the private vehicle 102, according to one embodiment.

An adherence algorithm 216 may determine if an individual 104A of the private vehicle 102 is obeying to the set of parameters (e.g., a set of parameters data 108) set by the entity 110 (e.g., insurance provider 110A, parent 110B, and/or a driving school operator 110C), according to one embodiment. A credit algorithm 218 may assign a valuable consideration to the individual 104A when the individual 104A follows to the set of parameters data 108 set by the entity 110, according to one embodiment.

FIG. 2 illustrates the central server 100 of FIG. 1 may include the credit function 114 and the benefit function 116 communicatively coupled with the memory 126, the processor 128 and the database 130. In FIG. 2, the credit function 114 may be communicatively coupled with the memory 126 and the violation algorithm 204, according to one embodiment. The violation algorithm 204 is illustrated in the embodiment of FIG. 2 as communicatively coupled with the configure algorithm 202 and the curfew algorithm 206. Further, the curfew algorithm 206 may be coupled with the processor 128 and the monitoring algorithm 208 as illustrated in FIG. 2. Further, monitoring algorithm 208 can be coupled with the insurance algorithm 210. Further, insurance algorithm 210 may be coupled with the affinity algorithm 212. Further, the affinity algorithm 212 can be coupled with the competition algorithm 214. Further, the competition algorithm 214 may be coupled with the adherence algorithm 216. Further, the adherence algorithm 216 may be coupled with the credit algorithm 218. Further, the credit algorithm 218 may be coupled with the configure algorithm 202.

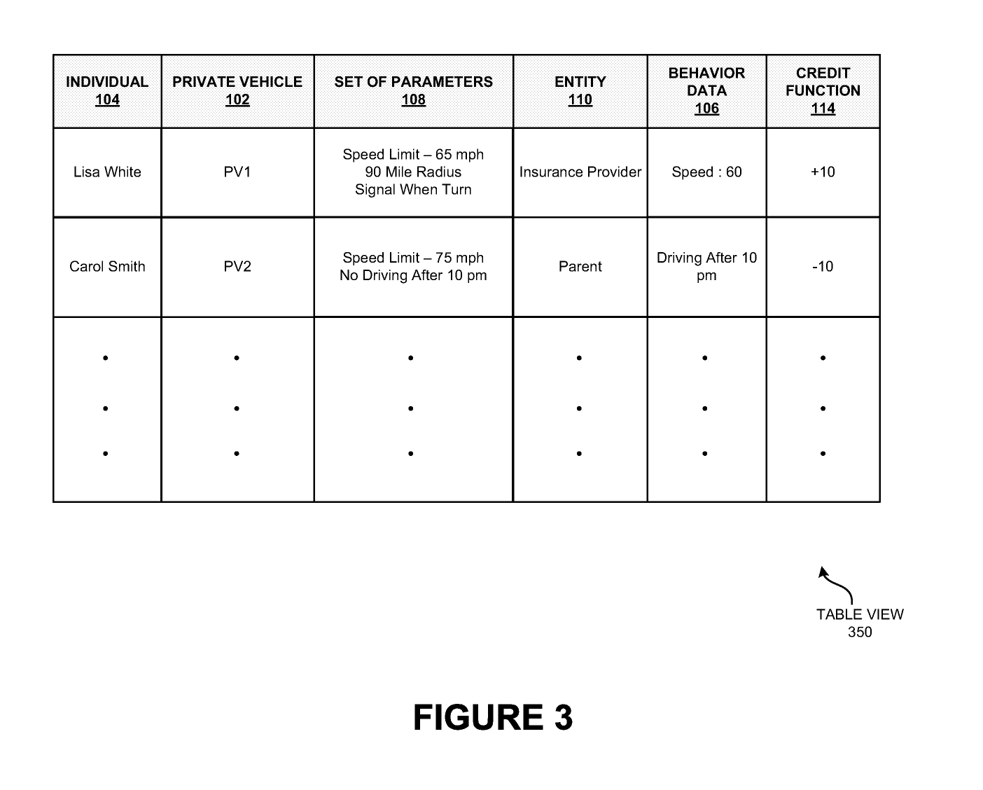

FIG. 3 is table view 350 illustrating the relationships between the individual 104A of the private vehicle 102, a set of parameters data 108 of FIG. 1, according to one embodiment. Particularly, FIG. 3 illustrates a set of fields stored in a table of a database 130 of the central server 100 of FIG. 1 including the individual 104A, the private vehicle 102, the set of parameters data 108, the entity 110, the behavior data 106, and/or the credit function 114. The table view 350 of FIG. 3 describes two entries. The first entry shows ‘Lisa White’ operating the private vehicle ‘PV1’ following the set of parameters with a ‘speed limit—65 mph, 90 mile radius, and signal when turn’ set by the ‘insurance provider’ may receive credit of ‘+10’. The second entry shows ‘Carol Smith’ operating the private vehicle ‘PV2’ disobeying the set of parameters when ‘driving after 10 pm’ set by the ‘parent’ may receive credit of ‘−10’.

The behavior (e.g., behavior data 106) of the individual 104A operating the private vehicle 102 following the set of parameters (e.g., a set of parameters data 108) set by the entity 110 may be monitored by the entity 110 (e.g. the insurance provider 110A, parent 110B, and the driving school operator 110C). The individual 104A may receive a credit when provided with benefit based on behavior of the individual 104A operating the private vehicle of FIG. 1.

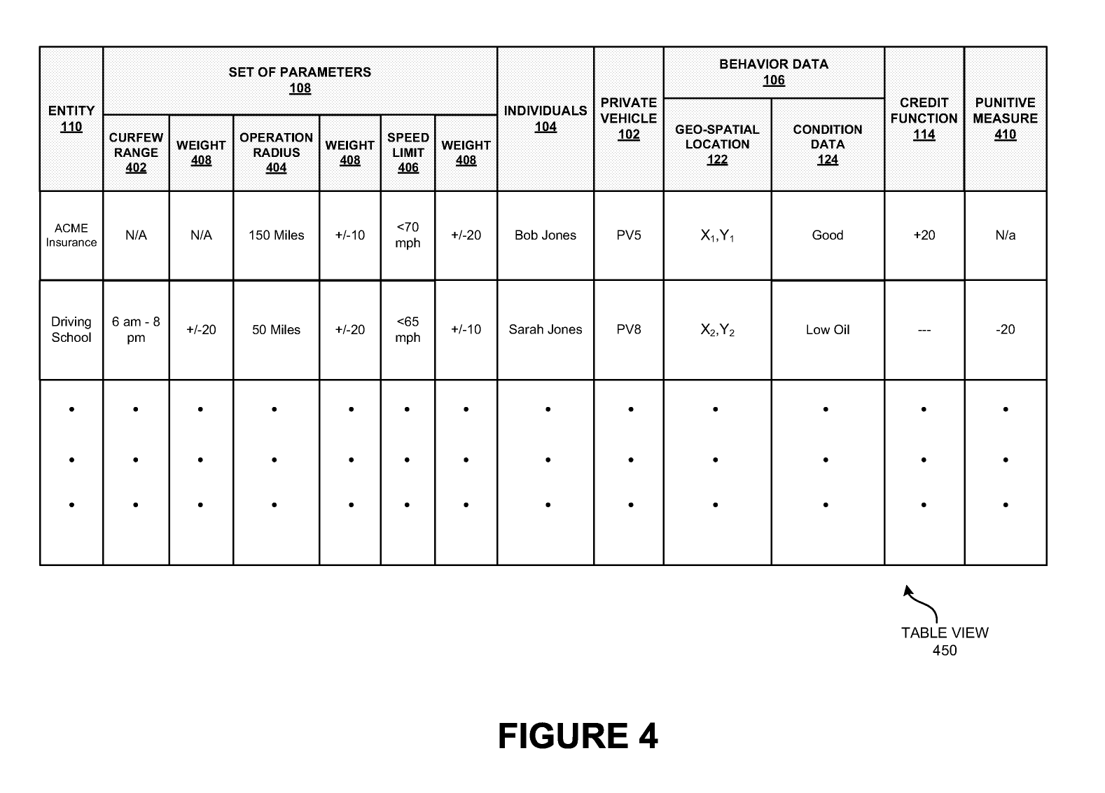

FIG. 4 is table view 450 illustrating the relationships between the set of parameters (e.g., a set of parameters data 108) stored in a database 130 of the central server 100 of FIG. 1 and the behavior data 106, according to one embodiment. Particularly, FIG. 4 illustrates a set of fields related to the entity 110, the set of parameters data 108 (e.g., a curfew range field 402, a weight field 408, an operation radius field 404, a speed limit field 406) the individuals 104, private vehicle 102, the behavior data 106 (e.g. geospatial location data 122, the condition data 124), a credit function 114, and a punitive measure field 410.

A curfew range field 402 may be a space in the database 130 of FIG. 1 allocated for storing information related to the specified restricted area set by the entity 110 based on the set of parameter (e.g., a set of parameters data 108) to safely drive the private vehicle 102 by the individual 104A, according to one embodiment.

An operation radius field 404 may be the space in the database 130 of FIG. 1 for storing information related to permissions for driving the private vehicle 102, according to one embodiment. A speed limit field 406 may be the space in the database 130 of FIG. 1 for storing information related to the maximum speediness at which the private vehicle 102 may travel on a road, according to one embodiment.

A weight field 408 may be a space in the database 130 of FIG. 1 for storing information related to the credited points offered by the entity 110 to the individual 104A for following the set of parameters (e.g., a set of parameters data 108), according to one embodiment. A punitive measure field 410 may be a space in the database 130 of FIG. 1 for storing information related to the disciplinary action taken by the entity 110 when the individual 104A of the private vehicle 102 may disobey the set of parameters (e.g., a set of parameters data 108) set by the entity 110, according to one embodiment.

In the table view 450 of FIG. 4 two entries are described. The first entry shows ‘Bob Jones’ operating the private vehicle ‘TV5’ with geospatial location ‘(x₁, y₂)’ in a ‘good’ condition with the set of parameters having ‘operation radius 150 miles’ and ‘weight+/−10’, ‘speed limit <70 mph’ having ‘weight+/−20’ set by the entity ‘ACME Insurance’ will receive credit of ‘+20’. The second entry shows ‘Sarah Jones’ operating the private vehicle ‘PV8’ with geospatial location ‘(x₂, y₂)’ with low oil′ condition having the set of parameters with curfew range of ‘6 am to 8 pm’, having weight ‘+/−20’, ‘operation radius 50 miles’ having weight ‘+/−20’, speed limit <65 mph′ having weight ‘+/−10’ set by the entity ‘Driving School’ will receive punitive measure ‘−20’.

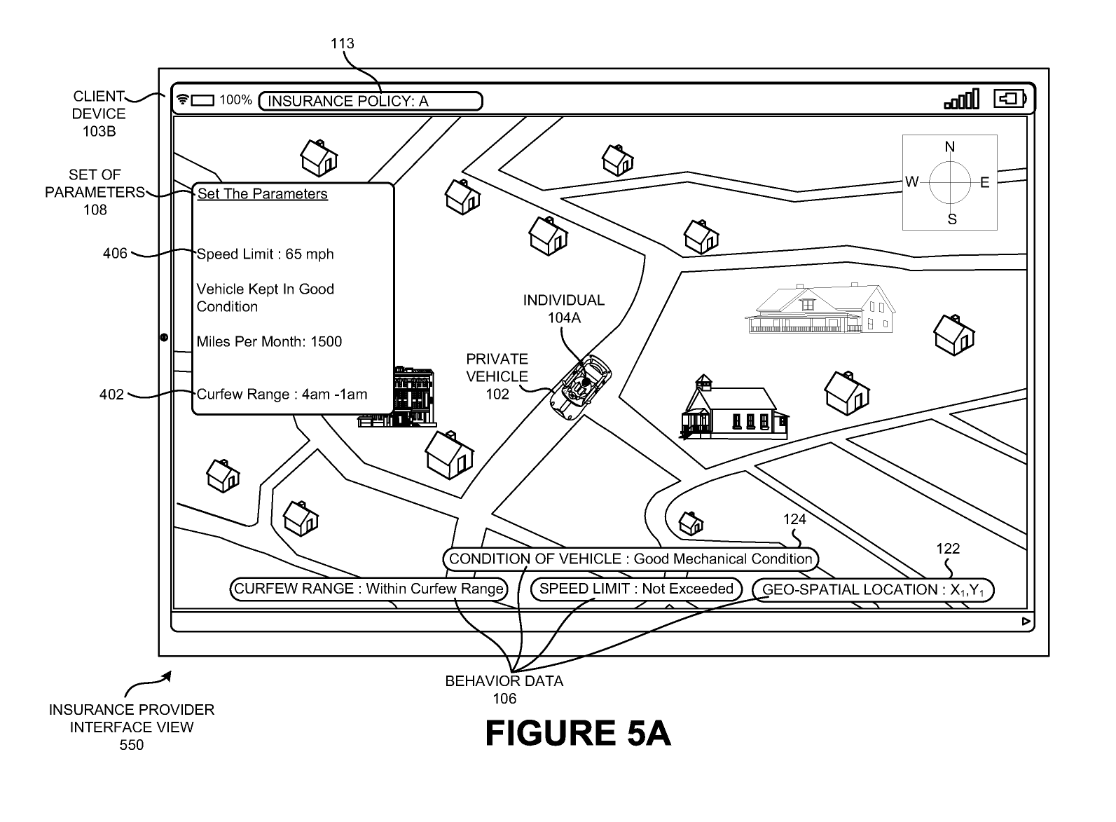

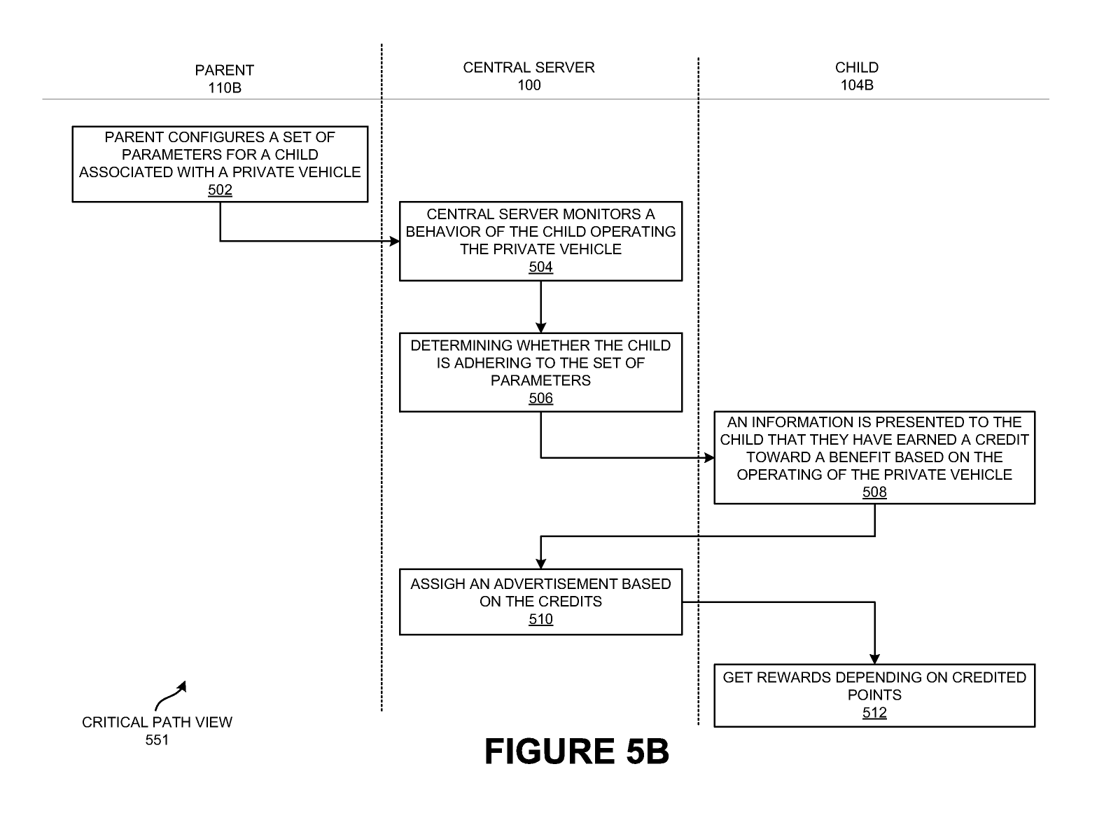

FIG. 5A is an insurance provider interface view 550 of the set of parameters data 108 of FIG. 1 in a client devices 103B-N, according to one embodiment. Particularly FIG. 5A illustrates, a client devices 103B-N of the insurance provider 110A monitoring the behavior of the individual 104A operating the private vehicle 102, the set of parameters data 108, the insurance policy 113, the geospatial location data 122, the condition data 124, the curfew range field 402, and/or speed limit field 406.

FIG. 5A is showing the insurance provider 110A setting the parameters data 108 (e.g., speed limit, curfew range). The client device 103B may monitor the behavior (e. g., behavior data 106) of the private vehicle 102 of the individual 104A of FIG. 1.

FIG. 5B is critical path view 551 illustrating a parent 110B using the central server 100 of FIG. 1 to monitor a behavior (e.g., behavior data 106) of a child 104B operating the private vehicle 102 and provide benefits and rewards, according to one embodiment.

In operation 502, parent 110B may configure the set of parameters (e.g., a set of parameters data 108) for the child 104B associated with the private vehicle 102. In operation 504, the central server 100 may monitor the behavior (e.g., behavior data 106) of the child 104B operating the private vehicle 102. In operation 506, the central server 100 may determine that the child 104B is adhering to the set of parameters (e.g., a set of parameters data 108). In operation 508, an information (e.g., information data 112) may be presented to the child 104B who have earned the credit (e.g., credit function 114) towards the benefit (e.g., benefit function 116) based on the operating of the private vehicle 102. In operation 510, the central server 100 may assign an advertisement based on the credits (e.g., credit function 114). In operation 512, the child 104B may get rewards depending on credits (e.g., credit function 114) earned.

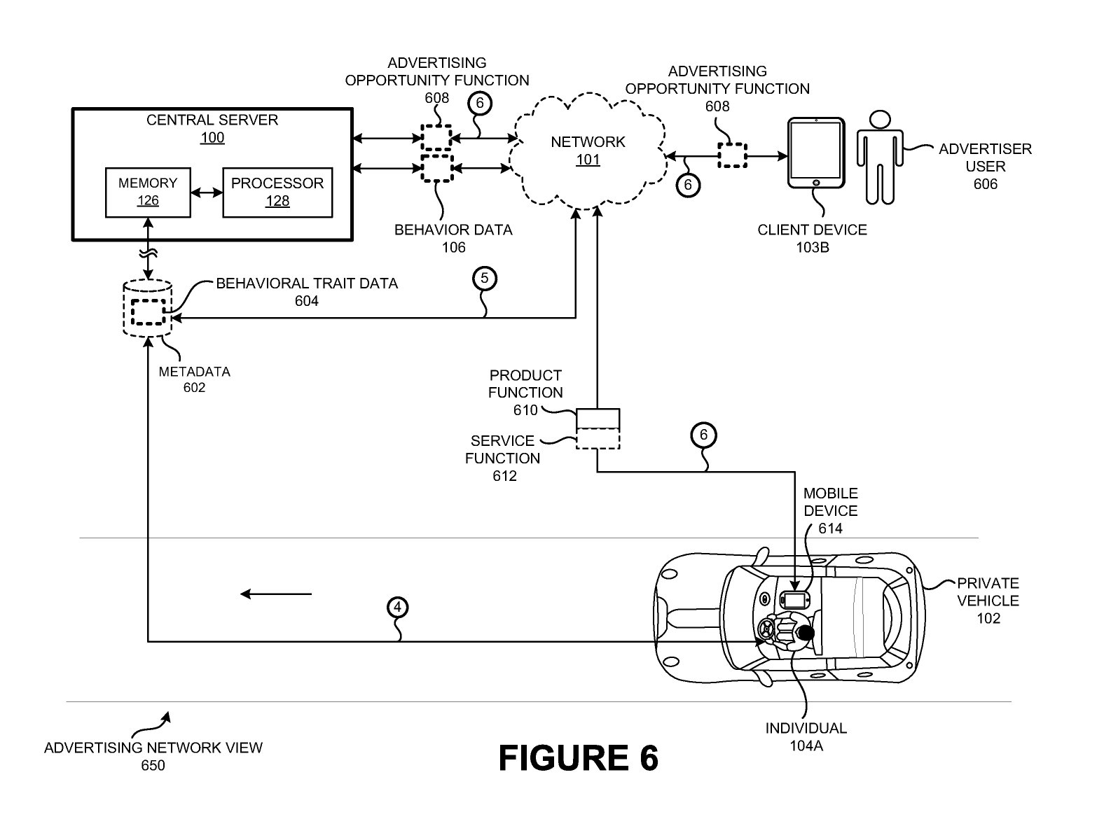

FIG. 6 is an advertising network view 650 of the central server 100 of FIG. 1 communicatively coupled with a behavioral trait data 604 of the individual 104A through the network 101 of FIG. 1, according to one embodiment. Particularly, FIG. 6 illustrates a metadata 602, the behavioral trait data 604, the advertiser user 606, an advertising opportunity function 608, the product function 610, the service function 612, and/or a mobile device 614. The central server 100 may be communicatively coupled with a client device 103B of the advertiser user 606 and the private vehicle 102 of the individual 104A.

A metadata 602 may be a particular set of data (e.g., behavioral trait data 604) may collect and describe other data, according to one embodiment. The behavioral trait data 604 may be the information collected from measuring and/or recording of the behavioral action relatively enduring characteristics of the individual 104A while driving the private vehicle 102, according to one embodiment.

The advertiser user 606 may be the entity 110 who may market a product and/or service as a reward and/or benefit for the individual 104A operating the private vehicle 102, according to one embodiment. An advertising opportunity function 608 may be set of circumstances that make the advertiser user 606 to promote an advertisement to the individuals 104 operating the private vehicle 102, according to one embodiment.

The product function 610 may be a set of instructions that perform a set of functions related to the goods which are offered to the individual 104A by the entity 110 (e.g., an advertiser user 606) that targets the behavioral trait (e.g., behavioral trait data 604), according to one embodiment. The service function 612 may be a set of instructions that perform a set of functions related to an amenity which is offered to the individual 104A by the entity 110 (e.g., an advertiser user 606) that targets the behavioral trait (e.g., behavioral trait data 604), according to one embodiment. A mobile device 614 may be a portable electronic device which may be used for communication between the entity 110 and the individual 104A though the network 101, according to one embodiment.

In circle ‘4’, the central server 100 of FIG. 1 of may generate the metadata 602 including the behavioral trait data 604 of the individual 104A operating the private vehicle 102. In circle ‘5’, the advertiser user 606 may be selected that targets the behavioral trait (e.g., behavioral trait data 604) in promotion of the product and/or the service. In circle ‘6’ the advertiser user 606 may be presented with an advertising opportunity (e.g., advertising opportunity function 608) by the entity 110 to the individual 104A operating the private vehicle 102 through the mobile device 614.

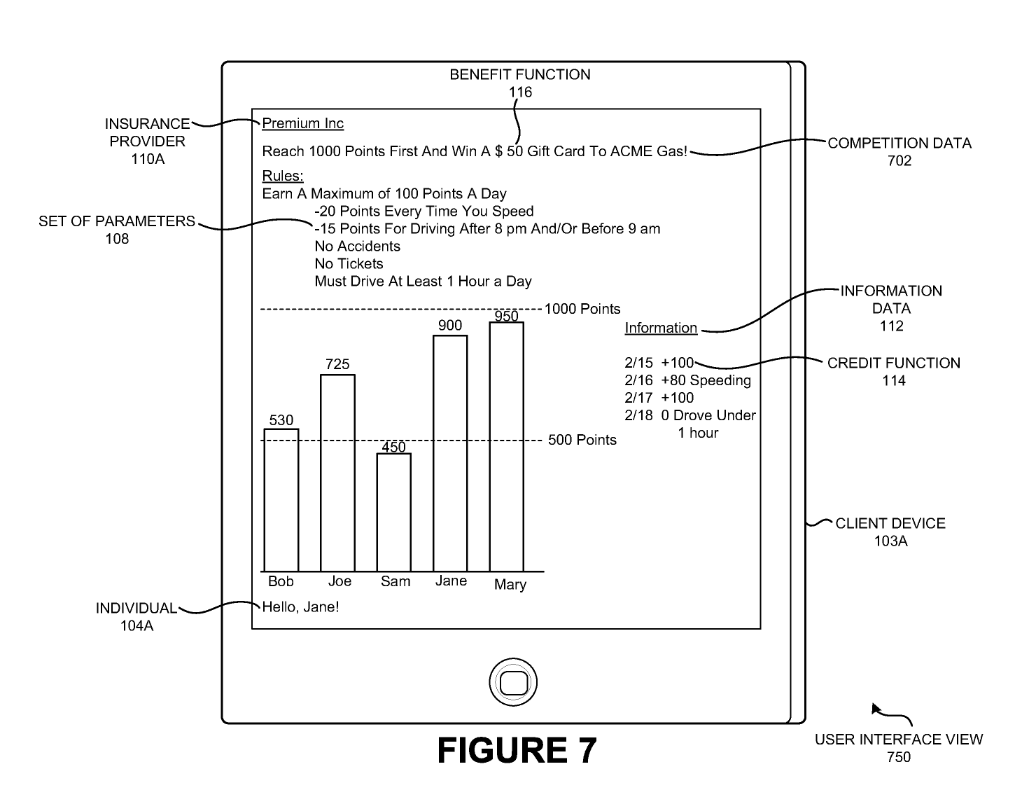

FIG. 7 is an interface view 750 of the client device 103A of FIG. 1 providing a benefit function 116 and a credit function 114 to the individual 104A of FIG. 1, according to one embodiment. Particularly, FIG. 7, illustrates the interface view of the client device 103A of an individual 104A operating the private vehicle 102. The individual 104A of the private vehicle 102 may receive benefit for following the set of parameters (e.g., a set of parameters data 108) set by the entity 110. The competition data 702 may be organized by the insurance provider 110A determining the set of parameters data 108 obeying by the individual 104A.

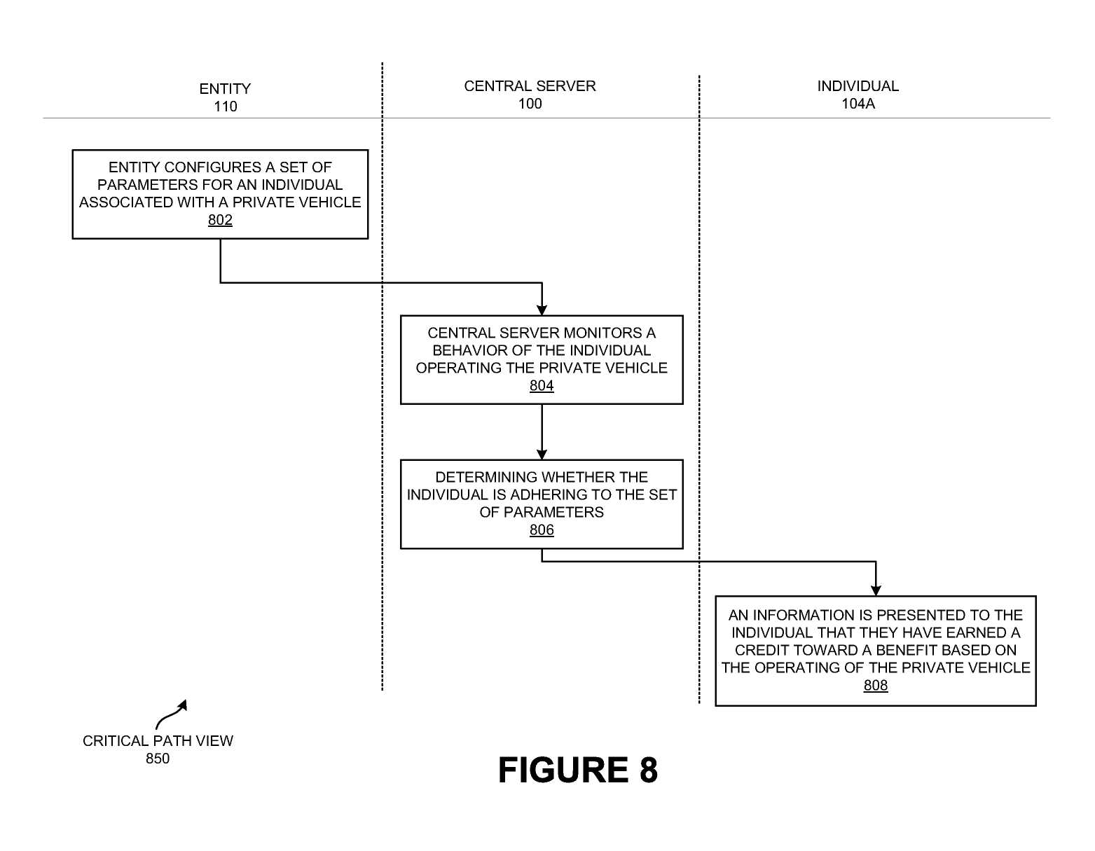

FIG. 8 is critical path view 850 illustrating the entity 110 using the central server 100 of FIG. 1 to monitor a behavior (e.g., behavior data 106) of the individual 104A operating the private vehicle 102, according to one embodiment.

In operation 802, the entity 110 may configure the set of parameters (e.g., a set of parameters data 108) for the individual 104A associated with the private vehicle 102. In operation 804, the central server 100 may monitor the behavior (e.g., behavior data 106) of the individual 104A operating the private vehicle 102. In operation 806, the central server 100 may determine that the individual 104A is adhering to the set of parameters data 108 set by the entity 110. In operation 808, an information (e.g., information data 112) may be presented to the individual 104A who have earned the credit (e.g., credit function 114) towards the benefit (e.g., benefit function 116) based on the operating of the private vehicle 102. In operation 810, the central server 100 may assign an advertisement based on the credits (e.g., credit function 114). In operation 812, the individual may get rewards depending on credits (e.g., credit function 114) earned.

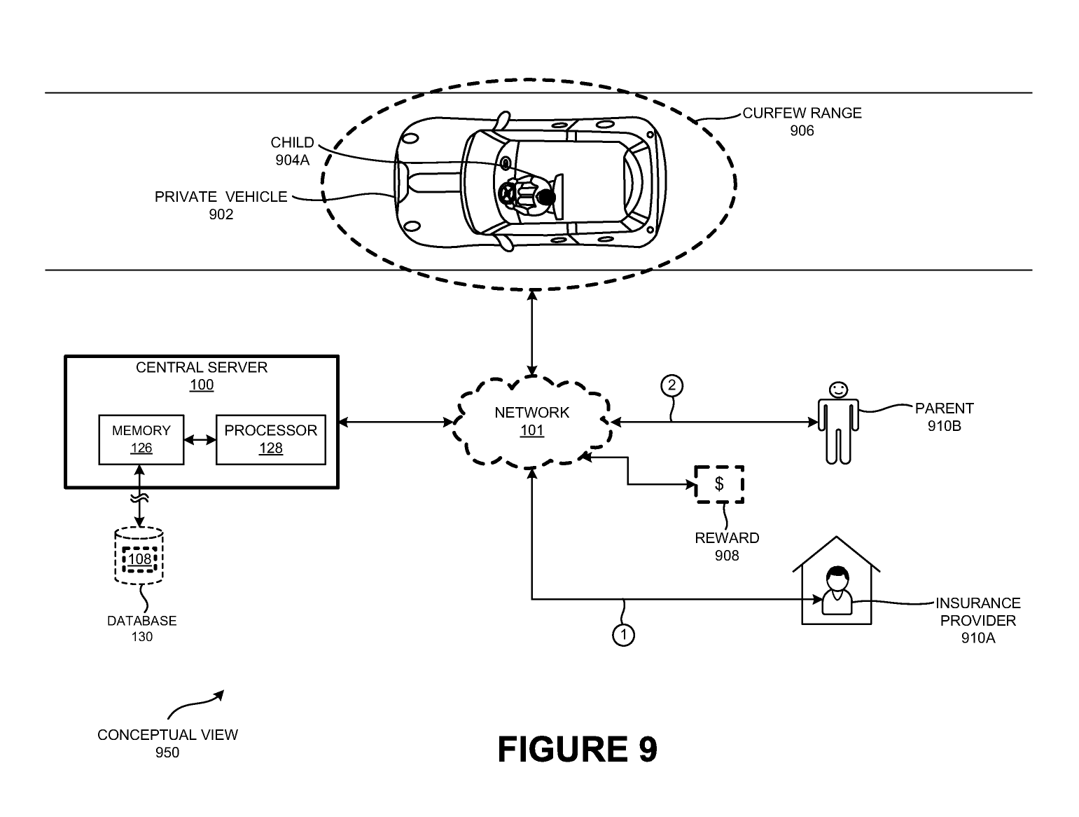

FIG. 9 is a conceptual view 950 of the central server 100 communicating with a child 904A operating a private vehicle 902, an insurance provider 110A and/or a parent 910B through the network 101. Particularly, FIG. 9 illustrates two different scenarios, as scenario ‘1’ and scenario ‘2’. In scenario ‘1’, the insurance provider 910A may offer the reward 908 (e.g., a discount on an insurance premium) to the child 904A (e.g., an insured driver) when the child 904A is driving the private vehicle 902 within a curfew range 906. For example, ‘KEICO’ insurance company may offer a 10% discount on an insurance premium to ‘Nick’ who is an insured driver when he may drive his ‘Car’ within the curfew range. In scenario ‘2’, the parent 910B may offer the reward 908 (e.g., a coupon, a food voucher, a video game) to the child 904A when the child 904A is driving the private vehicle 902 within the curfew range 906, according to one embodiment. For example, ‘Joe’ may offer a video game to his son ‘Chris’ when he may drive his ‘car’ within the curfew range.

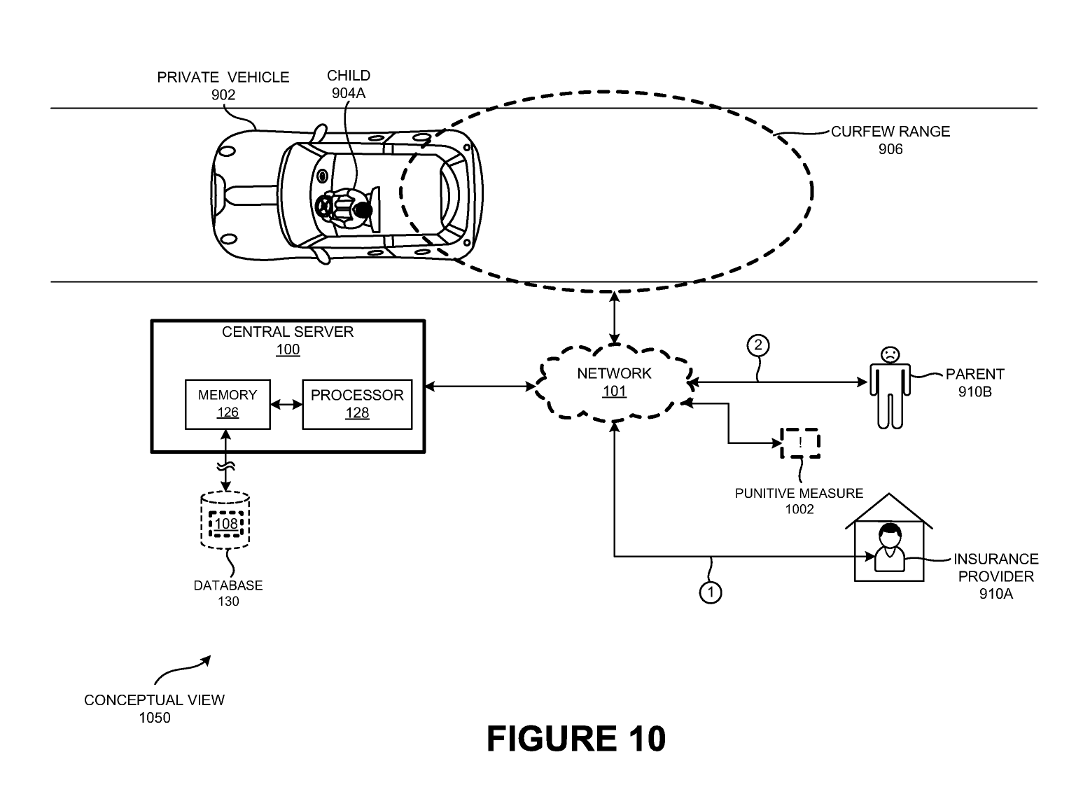

FIG. 10 is a conceptual view 1050 of the central server 100 communicating with a child 904A operating a private vehicle 902, an insurance provider 110A and/or a parent 910B through the network 101. FIG. 10 illustrates the punitive measure whereas FIG. 9 illustrates the rewards. Particularly, FIG. 10 illustrates two different scenarios, as scenario ‘1’ and scenario ‘2’. In scenario ‘1’, the insurance provider 910A may give the punitive measure 1002 (e.g., increasing the insurance rate, deducting money from an allowance) to the child 904A (e.g., an insured driver) when the child 904A is driving the private vehicle 902 out of a curfew range 906. For example, ‘KAMCO’ insurance provider may increase the insurance rate to ‘Jack’ who is an insured driver when he may drive his favorite ‘Green Honda Civic’ out of the curfew range. However, in scenario ‘2’, the parent 910B may give the punitive measure 1002 (e.g., deducting monthly allowance, cleaning the dishes, doing the laundry) to the child 904A when the child 904A is driving the private vehicle 902 out of the curfew range 906, according to one embodiment. For example, ‘Sam’ may tell his daughter ‘Jenny’ to clean the dishes when ‘Jenny’ may drive her favorite ‘car’ out of the curfew range.

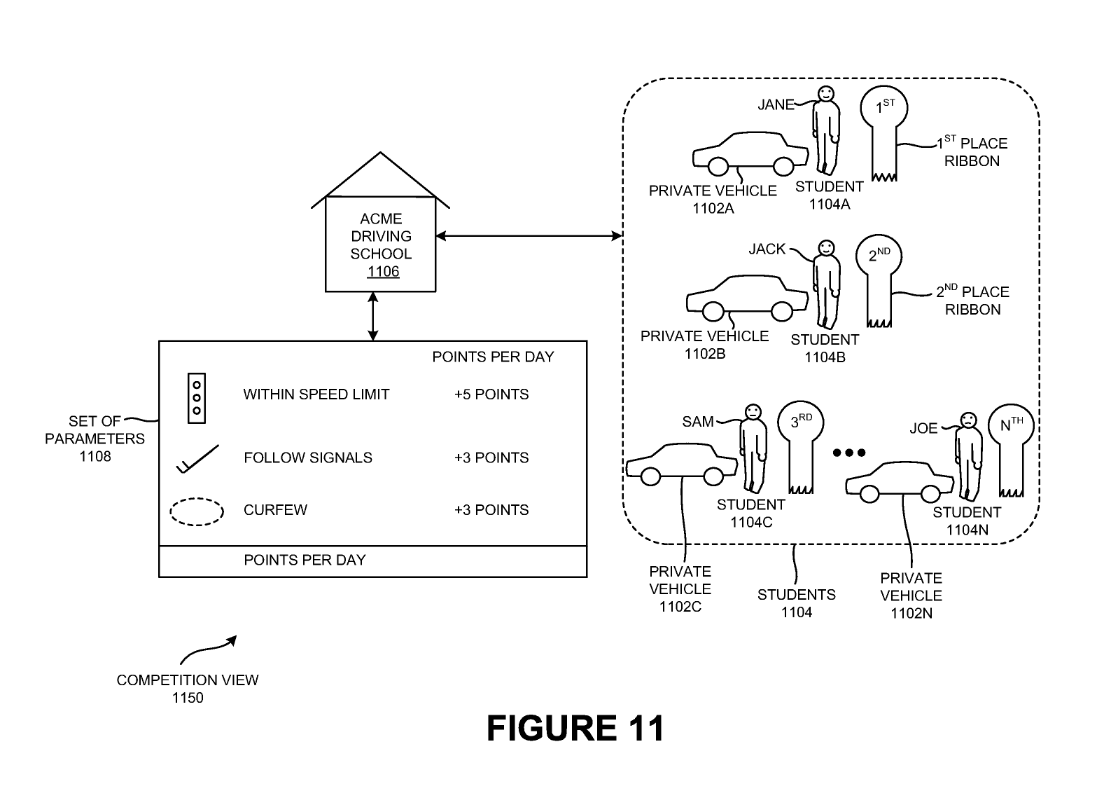

FIG. 11 is a competition view 1150 of the students 1104 of the ACME driving school 1106 competing for the recognition based on a set of parameters (e.g., a set of parameters data 1108) set by the ACME driving school 1106, according to one embodiment. Particularly, FIG. 11 illustrates that a competition may be organized by the ACME driving school 1106 between students 1104. For example, FIG. 11 illustrates that Jane may get a ‘1^{st} place ribbon’ winning a competition with other students by driving her private vehicle 1102 within a speed limit for the most consecutive days. For this accomplishment, Jane may earn ‘+5’ points. In contrast, another student, Jack may earn ‘+3’ points in the competition earning a 2^{nd} prize, as illustrated in FIG. 11.

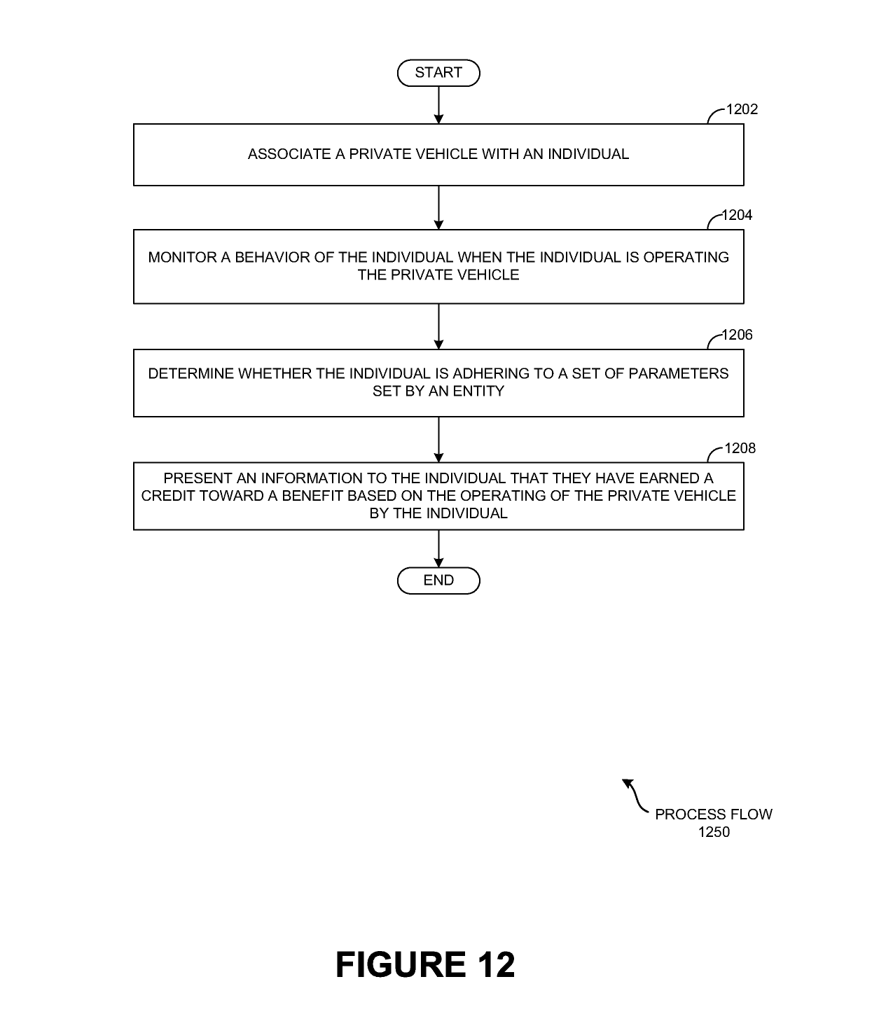

FIG. 12 is a process flow 1250 of the central server 100 of FIG. 1 monitoring the behavior (e.g., behavior data 106) of the individual 104A operating the private vehicle 102, according to one embodiment. Particularly, FIG. 12 illustrates the processes monitoring the behavior (e.g., behavior data 106) of the individual 104A. In operation 1202, a private vehicle 102 may be associated with the individual 104A. In operation 1204, a behavior (e.g., behavior data 106) of the individual 104A may be monitored when the individual 104A is operating the private vehicle 102. In operation 1206, the central server 100 may determine whether the individual 104A is adhering to a set of parameters (e.g., a set of parameters data 108) set by the entity 110. In operation 1208, information may be presented to the individual 104A that they have earned a credit toward a benefit based on the operating of the private vehicle 102 by the individual 104A.

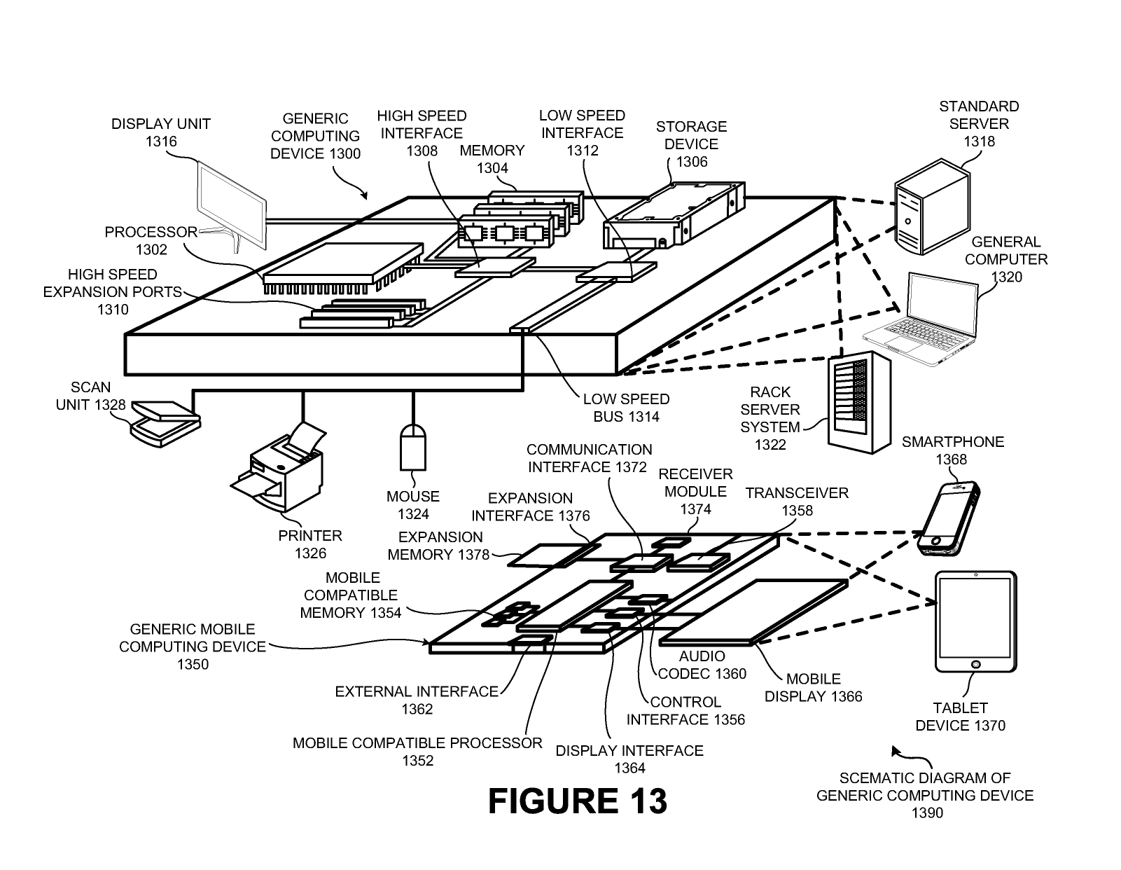

FIG. 13 is a schematic diagram of computing device 1300 that can be used to implement the methods and systems disclosed herein, according to one or more embodiments. FIG. 13 is a schematic of a computing device 1300 and a mobile device 1350 that can be used to perform and/or implement any of the embodiments disclosed herein. In one or more embodiments, central server 100 and/or client device 103A of FIG. 1 may be the computing device 1300.

The computing device 1300 may represent various forms of digital computers, such as laptops, desktops, workstations, personal digital assistants, servers, blade servers, mainframes, and/or other appropriate computers. The mobile device 1350 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

The computing device 1300 may include a processor 1302, a memory 1304, a storage device 1306, a high speed interface 1308 coupled to the memory 1304 and a plurality of high speed expansion ports 1310, and a low speed interface 1312 coupled to a low speed bus 1314 and a storage device 1306. In one embodiment, each of the components heretofore may be inter-coupled using various buses, and may be mounted on a common motherboard and/or in other manners as appropriate. The processor 1302 may process instructions for execution in the computing device 1300, including instructions stored in the memory 1304 and/or on the storage device 1306 to display a graphical information for a GUI on an external input/output device, such as a display unit 1316 coupled to the high speed interface 1308. In other embodiments, multiple processors and/or multiple buses may be used, as appropriate, along with multiple memories and/or types of memory. Also, a plurality of computing device 1300 may be coupled with, with each device providing portions of the necessary operations (e.g., as a server bank, a group of blade servers, and/or a multi-processor system).

The memory 1304 may be coupled to the computing device 1300. In one embodiment, the memory 1304 may be a volatile memory. In another embodiment, the memory 1304 may be a non-volatile memory. The memory 1304 may also be another form of computer-readable medium, such as a magnetic and/or an optical disk. The storage device 1306 may be capable of providing mass storage for the computing device 1300. In one embodiment, the storage device 1306 may be included of a floppy disk device, a hard disk device, an optical disk device, a tape device, a flash memory and/or other similar solid state memory device. In another embodiment, the storage device 1306 may be an array of the devices in a computer-readable medium previously mentioned heretofore, computer-readable medium, such as, and/or an array of devices, including devices in a storage area network and/or other configurations.

A computer program may be included of instructions that, when executed, perform one or more methods, such as those described above. The instructions may be stored in the memory 1304, the storage device 1306, a memory coupled to the processor 1302, and/or a propagated signal.

The high speed interface 1308 may manage bandwidth-intensive operations for the computing device 1300, while the low speed interface 1312 may manage lower bandwidth-intensive operations. Such allocation of functions is exemplary only. In one embodiment, the high speed interface 1308 may be coupled to the memory 1304, the display unit 1316 (e.g., through a graphics processor and/or an accelerator), and to the plurality of high speed expansion ports 1310, which may accept various expansion cards. In the embodiment, the low speed interface 1312 may be coupled to the storage device 1306 and the low speed bus 1314. The low speed bus 1314 may be included of a wired and/or wireless communication port (e.g., a Universal Serial Bus (“USB”), a Bluetooth® port, an Ethernet port, and/or a wireless Ethernet port). The low speed bus 1314 may also be coupled to scan unit 1328, a printer 1326, a keyboard, a mouse 1324, and a networking device (e.g., a switch and/or a router) through a network adapter.

The computing device 1300 may be implemented in a number of different forms, as shown in the figure. In one embodiment, the computing device 1300 may be implemented as a standard server 1318 and/or a group of such servers. In another embodiment, the computing device 1300 may be implemented as part of a rack server system 1322. In yet another embodiment, the computing device 1300 may be implemented as a general computer 1320 such as a laptop and/or desktop computer. Alternatively, a component from the computing device 1300 may be combined with another component in a mobile device 1350. In one or more embodiments, an entire system may be made up of a plurality of computing device 1300 and/or a plurality of computing device 1300 coupled to a plurality of mobile device 1350.

In one embodiment, the mobile device 1350 may include a mobile compatible processor 1352, a mobile compatible memory 1354, and an input/output device such as a mobile display 1366, a communication interface 1372, and a transceiver 1358, among other components. The mobile device 1350 may also be provided with a storage device, such as a Microdrive and/or other device, to provide additional storage. In one embodiment, the components indicated heretofore are inter-coupled using various buses, and several of the components may be mounted on a common motherboard.

The mobile compatible processor 1352 may execute instructions in the mobile device 1350, including instructions stored in the mobile compatible memory 1354. The mobile compatible processor 1352 may be implemented as a chipset of chips that include separate and multiple analog and digital processors. The mobile compatible processor 1352 may provide, for example, for coordination of the other components of the mobile device 1350, such as control of user interfaces, applications run by the mobile device 1350, and wireless communication by the mobile device 1350.

The mobile compatible processor 1352 may communicate with a user through the control interface 1356 and the display interface 1364 coupled to a mobile display 1366. In one embodiment, the mobile display 1366 may be a Thin-Film-Transistor Liquid Crystal Display (“TFT LCD”), an Organic Light Emitting Diode (“OLED”) display, and another appropriate display technology. The display interface 1364 may include appropriate circuitry for driving the mobile display 1366 to present graphical and other information to a user. The control interface 1356 may receive commands from a user and convert them for submission to the mobile compatible processor 1352. In addition, an external interface 1362 may be provided in communication with the mobile compatible processor 1352, so as to enable near area communication of the mobile device 1350 with other devices. External interface 1362 may provide, for example, for wired communication in some embodiments, and/or for wireless communication in other embodiments, and multiple interfaces may also be used.

The mobile compatible memory 1354 may be coupled to the mobile device 1350. The mobile compatible memory 1354 may be implemented as a volatile memory and a non-volatile memory. The expansion memory 1378 may also be coupled to the mobile device 1350 through the expansion interface 1376, which may include, for example, a Single In Line Memory Module (“SIMM”) card interface. The expansion memory 1378 may provide extra storage space for the mobile device 1350, and/or may also store an application and/or other information for the mobile device 1350. Specifically, the expansion memory 1378 may include instructions to carry out the processes described above. The expansion memory 1378 may also include secure information. For example, the expansion memory 1378 may be provided as a security module for the mobile device 1350, and may be programmed with instructions that permit secure use of the mobile device 1350. In addition, a secure application may be provided on the SIMM card, along with additional information, such as placing identifying information on the SIMM card in a non-hackable manner.

The mobile compatible memory 1354 may include a volatile memory (e.g., a flash memory) and a non-volatile memory (e.g., a non-volatile random-access memory (“NVRAM”)). In one embodiment, a computer program includes a set of instructions that, when executed, perform one or more methods. The set of instructions may be stored on the mobile compatible memory 1354, the expansion memory 1378, a memory coupled to the mobile compatible processor 1352, and a propagated signal that may be received, for example, over the transceiver 1358 and/or the external interface 1362.

The mobile device 1350 may communicate wirelessly through the communication interface 1372, which may be included of a digital signal processing circuitry. The communication interface 1372 may provide for communications using various modes and/or protocols, such as: a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol. Such communication may occur, for example, through the transceiver 1358 (e.g., radio-frequency transceiver). In addition, short-range communication may occur, such as using a Bluetooth®, Wi-Fi, and/or other such transceiver. In addition, a GPS (“Global Positioning System”) receiver module may provide additional navigation-related and location-related wireless data to the mobile device 1350, which may be used as appropriate by a software application running on the mobile device 1350.

The mobile device 1350 may also communicate audibly using an audio codec 1360, which may receive spoken information from a user and convert it to usable digital information. The audio codec 1360 may likewise generate audible sound for a user, such as through a speaker (e.g., in a handset of the mobile device 1350). Such a sound may include a sound from a voice telephone call, a recorded sound (e.g., a voice message, a music files, etc.) and may also include a sound generated by an application operating on the mobile device 1350.

The mobile device 1350 may be implemented in a number of different forms, as shown in the figure. In one embodiment, the mobile device 1350 may be implemented as a smartphone 1368. In another embodiment, the mobile device 1350 may be implemented as a personal digital assistant (“PDA”). In yet another embodiment, the mobile device, 1350 may be implemented as a tablet device 1370.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including programmable processor, which may be special and/or general purpose, coupled to receive data and instructions from, and to transmit data and instructions to, a storage system, input device, and output device.

These computer programs (also known as programs, software, software applications, and/or code) include machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse 1324 by which the user can provide input to the computer. Other kinds of devices can be used to provide for interaction with a user as well; for example, feedback provided to the user can be any form of sensory feedback (e.g., visual feedback, auditory feedback, and/or tactile feed-back) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the figures do not require the particular order shown, and/or sequential order, to achieve desirable results. In addition, other steps may be provided, or steps may be eliminated, from the described flows, and other components may be added to, and/or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method comprising:
associating a private vehicle with an individual;
monitoring a behavior of the individual when the individual is operating the private vehicle;
determining whether the individual is adhering to a set of parameters set by an entity using a processor and a memory; and
presenting an information to the individual that they have earned a credit toward a benefit based on the operating of the private vehicle by the individual.

2. The method of claim 1 further comprising:
permitting the entity to configure the set of parameters including permitting the entity to set a weight to each of the set of parameters.

3. The method of claim 2 further comprising:
providing a punitive measure when the set of parameters is violated.

4. The method of claim 1 further comprising:
setting a curfew range on the private vehicle such that a movement of the private vehicle is limited to the curfew range; and
monitoring a set of sensors of the private vehicle to determine a geospatial location and a condition of the private vehicle.

5. The method of claim 1 further comprising:
setting an insurance policy through an insurance provider based on at least adherence to the set of parameters.

6. The method of claim 1 further comprising:
generating a metadata comprising a behavioral trait of the individual operating the private vehicle;
selecting an advertiser that targets the behavioral trait in promotion of a product and a service; and
presenting the advertiser with an advertising opportunity to the individual operating the private vehicle through a mobile device of the individual.

7. The method of claim 1 further comprising:
creating a competition between individuals of a insurance provider;
determining if a particular individual is adhering to the set of parameters set by the entity; and
assigning the credit to the individual when the individual adheres to the set of parameters set by the entity, wherein the entity is the insurance provider,
wherein the individual is monitored by the entity, wherein the entity is the insurance provider.

8. A method comprising:
associating a private vehicle with an individual;
monitoring a behavior of the individual when the individual is operating the private vehicle;
permitting an entity to configure a set of parameters;
permitting the entity to assign a weight to each of the set of parameters using a processor and a memory; and
determining whether the individual is adhering to a set of parameters set by the entity.

9. The method of claim 8 further comprising:
presenting an information to the individual that they have earned a credit toward a benefit based on the operating of the private vehicle by the individual.

10. The method of claim 9 further comprising:
providing a punitive measure when the set of parameters is violated.

11. The method of claim 8 further comprising:
setting a curfew range on the private vehicle such that a movement of the private vehicle is limited to the curfew range; and
monitoring a set of sensors of the private vehicle to determine a geospatial location and a condition of the private vehicle.

12. The method of claim 8 further comprising:
setting an insurance policy through an insurance provider based on at least adherence to the set of parameters.

13. The method of claim 8 further comprising:
generating a metadata comprising a behavioral trait of the individual operating the private vehicle;
selecting an advertiser that targets the behavioral trait in promotion of a product and a service; and
presenting the advertiser with an advertising opportunity to the individual operating the private vehicle through a mobile device of the individual.

14. The method of claim 8 further comprising:
creating a competition between individuals of a insurance provider;
determining if a particular individual is adhering to the set of parameters set by the entity; and
assigning a credit to the individual when the individual adheres to the set of parameters set by the entity, wherein the entity is the insurance provider,
wherein the individual is monitored by the entity, wherein the entity is the insurance provider.

15. A system comprising:
a private vehicle associated with an individual; and
a central server configured to:
monitor a behavior of the individual when the individual is operating the private vehicle,
determine whether the individual is adhering to a set of parameters set by an entity using a processor and a memory, and
present an information to the individual that they have earned a credit toward a benefit based on the operating of the private vehicle by the individual.

16. The system of claim 15 further comprising:
a configure algorithm to permit the entity to configure the set of parameters including permitting the entity to set a weight to each of the set of parameters; and
a violation algorithm to provide a punitive measure when the set of parameters is violated.

17. The system of claim 15 further comprising:
a curfew algorithm to set a curfew range on the private vehicle such that a movement of the private vehicle is limited to the curfew range; and
a monitoring algorithm to monitor a set of sensors of the private vehicle to determine a geospatial location and a condition of the private vehicle.

18. The system of claim 15 further comprising:
an insurance algorithm to set an insurance policy through an insurance provider based on at least adherence to the set of parameters.

19. The system of claim 15 further comprising:
an affinity algorithm to:
generate a metadata comprising a behavioral trait of the individual operating the private vehicle,
select an advertiser that targets the behavioral trait in promotion of a product and a service, and
present the advertiser with an advertising opportunity to the individual operating the private vehicle through a mobile device of the individual,
wherein the entity is an insurance provider.

20. The system of claim 19 further comprising:
a competition algorithm to create a competition between individuals of the insurance provider;
an adherence algorithm to determine if the individual is adhering to the set of parameters set by the entity; and
a credit algorithm to assign the credit to the individual when the individual adheres to the set of parameters set by the entity, wherein the entity is the insurance provider,
wherein the individual is monitored by the entity, wherein the entity is the insurance provider.
